(19) United States
(12) Patent Application Publication
(10) Pub. No.: US 2024/0343490 A1
(43) Pub. Date: Oct. 17, 2024

(54) Method For Managing A Storage System, A Goods System And/Or A Production System, And System

(71) Applicant: Ekko GmbH, Wittenberg (DE)

(72) Inventors: Rouven FALKEWITZ, Witten (DE); Benny Philip LEHMANN, Witten (DE)

(21) Appl. No.: 18/634,245

(22) Filed: Apr. 12, 2024

(30) Foreign Application Priority Data
Apr. 14, 2023 (EP) 23168066.1

(51) Int. Cl. B65G 1/137; G06K 7/10; G06Q 10/0875

(52) U.S. Cl. CPC B65G 1/1371; G06K 7/10396; G06K 7/10445; G06Q 10/0875; G06K 2007/10524

(57) ABSTRACT

A method for managing a storage system, a goods system and/or a production system, comprising: acquiring information stored in an identifier (2) with a mobile data acquisition device (3); transmitting the information to a management system (1) connected to the mobile data acquisition device (3) for data exchange; identifying, on the basis of the transmitted information, at least one object (4) of a plurality of objects by the management system (1), wherein each object (4) is assigned a unique industrial coordinate (5) of an industrial coordinate system (6); creating an instruction depending on the identified object (4), its industrial coordinates (5) and/or the transmitted information, and transmitting the instruction from the management system (1) to the mobile data acquisition device (3), the identified object (4) and/or to an external device; wherein the industrial coordinates (5) comprise at least one hierarchy level (8) and at least one, a plurality of or all hierarchy levels (8) correspond to a physical property of the object (4) assigned to the respective industrial coordinate (5). The invention also relates to a corresponding system (100).

### CROSS-REFERENCE TO RELATED APPLICATIONS

The present application is based on, and claims priority from European Patent Application No. 23168066.1, filed Apr. 14, 2023, the disclosure of which is hereby incorporated by reference herein in its entirety.

### BACKGROUND OF THE INVENTION

### Technical Field

The invention relates to a method for managing a storage system, a goods system and/or a production system. The invention also relates to a system which has a corresponding management system.

Storage systems, goods systems and production systems generally comprise the management of goods or products. In this case, the number and/or position, such as, for example, a storage location, of the goods or products is usually detected or determined in order, for example, to have to keep lower stocks available or in order to achieve better production timing.

In particular, a low number of faults is desirable in order to save costs or to avoid or at least reduce production failures. For this purpose, goods or products must be able to be managed, identified or assigned simply, quickly and uncomplicated by the corresponding management system, but also by human operators or users, for example workers or operating personnel. In addition, incorrect or faulty assignments should be easily identifiable.

### BRIEF SUMMARY OF THE INVENTION

A first aspect relates to a method for managing a storage system, a goods system and/or a production system, comprising the steps of:
acquiring an identifier with a mobile data acquisition device, wherein the mobile data acquisition device acquires information stored in the identifier;
transmitting the information to a management system connected to the mobile data acquisition device for data exchange;
identifying at least one object of a plurality of objects by the management system, wherein a unique industrial coordinate of an industrial coordinate system is assigned to each object and, during the identification, the unique industrial coordinates of the object to be identified are determined on the basis of the transmitted information;
creating an instruction on the basis of the identified object, the industrial coordinates thereof and/or the transmitted information, and transmitting the instruction from the management system to the mobile data acquisition device, the identified object and/or to an external device connected to the management system for data exchange;
wherein the industrial coordinates comprise at least one hierarchy level and at least one, a plurality of or all hierarchy levels correspond to a physical property of the object assigned to the respective industrial coordinate.

Provision may be made for the industrial coordinate system to structure the industrial coordinates in a tree-shaped structure. The industrial coordinate system and/or the industrial coordinates may have a tree structure. The industrial coordinates may be grouped, for example tree-shaped.

The industrial coordinate system and/or the industrial coordinates may have some, a plurality of or all of the technical effects and/or advantages described below.

By virtue of the fact that at least one, a plurality of or all hierarchy levels correspond to a physical property of an object, and/or represent and/or map a physical property, objects may simply be grouped and/or linked in the industrial coordinate system.

In addition, the objects and the industrial coordinates assigned thereto may simply be verified, since the physical properties of the (real) objects can be easily and simply checked and compared with the corresponding hierarchy levels and/or the industrial coordinates, and/or the constituents of the industrial coordinates.

Provision may be made for the industrial coordinates and/or the constituents thereof to be selected in such a way that they can be interpreted for a human being directly as the corresponding physical property. The comparability can thus be further increased. However, a corresponding designation is not absolutely necessary; the corresponding hierarchy levels and/or the industrial coordinates, and/or the constituents of the industrial coordinates, may then also represent physical properties, even if they cannot be correspondingly assigned directly or at first glance by a human being. In some embodiments, for example, correspondence lists, equivalence lists, dictionaries or the like may be provided.

By virtue of the fact that at least one, a plurality of or all hierarchy levels correspond to a physical property of an object, and/or represent and/or map a physical property, and correspondingly the objects may simply be grouped and/or linked in the industrial coordinate system, new industrial coordinates may simply and uncomplicatedly be inserted. By virtue of the fact that the industrial coordinate system has a tree-shaped structure, the industrial coordinates may be grouped and/or linked, and new industrial coordinates may simply and uncomplicatedly be inserted. By virtue of the grouping, memory requirements may be reduced. By virtue of the grouping, an access time and/or retrieval time of the industrial coordinates may be reduced. For example, grouped industrial coordinates may be stored close to one another in a memory.

By virtue of the fact that at least one, a plurality of or all hierarchy levels correspond to a physical property of an object, and/or represent and/or map a physical property, a status of the system, of the management system, and/or of the goods and/or products may already be determined and/or ascertained by the industrial coordinate system. In particular, a downstream analysis or evaluation of a status of the system, of the management system, and/or of the goods and/or products may be significantly accelerated, or even a downstream analysis or evaluation may be dispensed with. Provision may be made for the industrial coordinate system to itself already map and/or represent the status.

Provision may be made for at least one industrial coordinate to be monitored, checked and/or verified in an ongoing, in-turn and/or periodic manner. Provision may be made for at least one industrial coordinate to be updated in an ongoing, in-turn and/or periodic manner. By virtue of the updating, for example, the actual state of the object may be brought into agreement or agreement with that mapped and/or represented by the corresponding industrial coordinate.

An industrial coordinate may consist of a plurality of constituents and/or have a plurality of constituents. An industrial coordinate may have one constituent per hierarchy level. Provision may be made for one industrial coordinate to have one constituent in a hierarchy level, and another industrial coordinate to have no constituent in this hierarchy level. Provision may be made for at least two industrial coordinates to have and/or comprise at least one different hierarchy level.

The industrial coordinate system may have and/or define or structure the hierarchy levels. Provision may also be made for the industrial coordinate system to have a number of hierarchy levels, and at least one industrial coordinate to comprise or consist of a number of constituents smaller than the number of hierarchy levels of the industrial coordinate system. In other words, an industrial coordinate does not absolutely have to have or comprise one constituent for each hierarchy level of the industrial coordinate system. If an industrial coordinate has one constituent in a hierarchy level, and/or one constituent assigned to a hierarchy level, the industrial coordinate may comprise the corresponding hierarchy level.

One, a plurality of or all industrial coordinates may be or have an alphanumeric string and/or an alphanumeric character string.

By virtue of the fact that the identifier is or is acquired by the mobile data acquisition device, the method can be carried out flexibly and simply, for example by an operator and/or user. The operator and/or user may be a worker or operating personnel. Provision may be made for the management system to be able to manage access rights and/or user rights. By way of example, a user and/or operator may have a user access and/or an account with which he can access the management system. Provision may be made, for example, for one, a plurality of or all industrial coordinates to be inaccessible to at least one, a plurality of or all users, and/or for the user not to be or be able to be read, changed, deleted or manipulated. By way of example, a particular user may only have access to or access to industrial coordinates which are enabled for him and/or are correspondingly assigned to his user rights.

Provision may likewise be made for machines, computers, production tools or the like connected to the management system for data exchange to only have access to industrial coordinates which are enabled in each case. Provision may be made for access rights to be set up for machines, computers, production tools or the like connected to the management system for data exchange. Machines, computers, production tools or the like connected to the management system for data exchange may have a user access and/or an account.

The management system or the industrial coordinate system may thus in particular also enable the management of user rights and roles for people and machines. The corresponding rights and roles may be or be distributed, set up and/or changed for example on the basis of generated data (e.g. scans), analyses and/or machine learning processes. The corresponding rights and roles may be or be distributed, set up and/or changed for example on the industrial coordinates.

In some embodiments, provision may be made to optimize, on the basis of and/or on the basis of industrial coordinates, generated data (e.g. scans), analyses and/or machine learning processes, e.g. travel routes, e.g. of users, workers such as warehouse keepers, or other personnel, and/or processes and/or warehouses, e.g. stockkeeping, inventory, cycle times, transit times, work sequences, a sequence of processing steps or the like.

In some embodiments, the industrial coordinate system and/or the industrial coordinates may be analyzed and/or evaluated for this purpose, for example by means of machine learning.

At least one object may be or comprise a good, a product, a starting material, an intermediate product, an end product, a component, a semi-finished product, or the like. Alternatively or additionally, at least one object may be or comprise a compartment, a container, a container, a shelf, a board, a table, or the like, e.g. for storing a good or a product. Alternatively or additionally, at least one object may be or comprise a machine, a production machine, a machine tool, a production plant, a production tool, a tool, a transport means or a transport unit, or the like. Alternatively or additionally, at least one object may be or comprise an electronic label.

Alternatively or additionally, the object may be or comprise a tablet. In some embodiments, it may be provided, e.g., that the object may be or comprise a tablet or the like, and the transmitted instruction may comprise an instruction to a user and/or operator. For example, a picker may be instructed and/or instructed via the tablet to remove, transport and/or store one or more specific objects. For example, a worker may be instructed and/or instructed via the tablet to carry out one or more specific work steps and/or production steps. It may be provided that the object may be identical to the mobile data acquisition device and/or may correspond to the mobile data acquisition device.

In some embodiments, an order, a work instruction or the like may be transmitted to a user, e.g., a picker, work, warehouse worker or the like, such that the order may be transmitted to the mobile data acquisition device or a mobile device of the user, e.g., a or the tablet. The user may then execute the order, for example by carrying out a method described above. Alternatively or additionally, an order, an instruction or the like may be started and/or initiated by the user, for example by carrying out a method described above, and/or by the user detecting and/or scanning an order slip, running slip, instruction or the like with a mobile device and/or the mobile data acquisition device. The system may be or comprise a storage system, a goods system and/or a production system.

Physical properties may be measurable and/or determinable. For example, a dimension or dimension of an object may be a physical property. For example, a material of which an object consists or which it comprises may be a physical property. For example, a state of an object may be a physical property. For example, an operating mode of an object may be a physical property. For example, a position and/or a location may be a physical property. For example, a temperature, a pressure and/or an aggregate state may be a physical property. For example, a quantity and/or a number may be a physical property. This list is not exhaustive; depending on the type or type of the object, other, a plurality, fewer or further physical properties are possible.

For example, one, a plurality or all hierarchy levels may correspond to one or more of installation location, storage location, operating mode, clock, machine type, product (e.g. type, type, state, etc.) and/or production information of the object assigned to the respective industrial coordinate.

The acquired and/or transmitted information may be suitable for identifying an object or the object and/or for defining the instruction to be created by the management system or at least for being taken into account in the creation thereof. For example, the acquired and/or transmitted information may comprise one or more industrial coordinates or consist of one or more industrial coordinates. For example, the acquired and/or transmitted information may comprise one or more instructions, control commands and/or messages which the management system can take into account and/or use in the identification and/or in the creation of the instruction.

For example, the transmitted information may be at least partially compared with industrial coordinates of the industrial coordinate system uniquely assigned to the respective objects, e.g. during the identification.

The instruction created by the management system may serve to generate a feedback and/or a reaction to the acquisition of the identifier. The manner of the feedback and/or reaction may depend on the method, the identifier, the acquired and/or transmitted information, the identified object or the like.

In some embodiments, an instruction may be or comprise a command, a control command, a machine command, a programming command, an instruction, a program instruction and/or a computer instruction or the like. In some embodiments, an instruction may comprise and/or contain data, instructions, messages or the like which may e.g. serve to execute the instruction, and/or with which e.g. the instruction may be executed and/or implemented.

It may be provided that the mobile data acquisition device, the identified object and/or the external device may execute the instruction and/or an action predefined by the instruction after receiving the instruction.

The external device may for example be or comprise a computer unit. The external device may e.g. be or comprise a desktop PC, a laptop, a tablet, a smartphone, a mobile device, a server or the like. Alternatively or additionally, the external device may be or comprise a machine, e.g. a production machine, a machine tool, a production machine, a production equipment, a transport unit and/or a transport device, or the like.

The identifier may be acquired by a handheld scanner. Alternatively or additionally, the identifier may be acquired by a functional glove.

When transmitting the information, auxiliary information may be transmitted. The auxiliary information may comprise, for example, a location or a position. It may be provided that the auxiliary information may alternatively or additionally comprise one or more physical properties of the object to be identified. When identifying the object, the identification may take place taking into account the auxiliary information. When identifying and/or matching, the matching may take place taking into account the auxiliary information. By virtue of the fact that the industrial coordinates may be grouped, the auxiliary information may, for example, provide an indication of the group to which the industrial coordinate of the object to be identified may belong.

The method may be usable and/or used for picking goods and/or components by means of pick-by-light.

When acquiring the identifier, an order slip may be acquired. Provision may be made for the order slip to be scanned. The order slip may comprise one or more goods to be picked. In some embodiments, in each case an industrial coordinate of the respective good to be picked and/or in each case an industrial coordinate of a respective electronic label assigned to the good to be picked may be acquired. When identifying an electronic label arranged on or at the goods to be picked may be identified as an object to be identified. When creating the instruction, an instruction which may instruct the identified electronic label to light up and/or to flash may be created. The instruction may be transmitted to the identified electronic label. The identified electronic label may light up and/or flash after the transmission.

The electronic label may comprise one or more lighting means, e.g. LEDs. The electronic label may be configured to flash and/or light up in different colours. Provision may be made for colour and/or frequency to be varied, selected and/or predefined. For example, the colour and/or the frequency may be selected and/or predefined to the user, e.g. user account or the like, an object to be picked or the like, depending on the industrial coordinate, the identified object and/or e.g. a location, for example a container, compartment, a storage shelf, one or the like, from which an object is to be or is to be removed. In some embodiments, the predefined colour and/or frequency may be part of the instruction. In some embodiments, the colour and/or frequency may be selected, predefined and/or varied such that instructions, commands and/or information may be transmitted to a user, e.g., a picker and/or warehouse worker, which may be based on and/or correspond to the colour and/or frequency, for example. In some embodiments, provision may be made for a specific colour and/or frequency to be assigned to at least one, more or all users, e.g., pickers and/or warehouse workers, and/or user accounts. The colour and/or frequency may be user-specific, e.g. picker-specific.

The method may be usable and/or used for storage by means of put-to-light. At least one industrial coordinate may be assigned to the industrial coordinate system.

A part identifier of a good to be stored may be acquired. In some embodiments, a part identifier arranged on or at the good to be stored may be acquired. The part identifier may be acquired with a or the mobile data acquisition device, wherein part identification data of the part identifier may be acquired. The part identification data may be transmitted to the management system connected to the mobile data acquisition device for data exchange. An electronic label may be acquired with the mobile data acquisition device, wherein label identification data of the electronic label may be acquired. The label identification data may be transmitted to the management system connected to the mobile data acquisition device for data exchange. An industrial coordinate, which may be assigned to the electronic label and/or the product, may be created by and/or with the management system. After the creation of the industrial coordinate, an instruction may be transmitted from the management system to the electronic label. The instruction may instruct the electronic label to light up and/or to flash. After the transmission of the instruction, the electronic label may light up and/or flash.

The electronic label may comprise one or more lighting means, e.g. LEDs. The electronic label may be configured to flash and/or light up in different colours. Provision may be made for colour and/or frequency to be varied, selected and/or predefined. For example, the colour and/or the frequency may be selected and/or predefined to the user, e.g. user account or the like, an object to be deposited or the like, depending on the industrial coordinate, the identified object and/or e.g. a location, for example a container, compartment, a storage shelf, one or the like, at which an object is to be or is to be deposited and/or stored. In some embodiments, the predefined colour and/or frequency may be part of the instruction. In some embodiments, the colour and/or frequency may be selected, predefined and/or varied such that instructions, commands and/or information may be transmitted to a user, e.g., a picker and/or warehouse worker, which may be based on and/or correspond to the colour and/or frequency, for example. In some embodiments, provision may be made for a specific colour and/or frequency to be assigned to at least one, more or all users, e.g., pickers and/or warehouse workers, and/or user accounts. The colour and/or frequency may be user-specific.

The label identification data may be used to identify and/or determine an electronic label. Provision may also be made for the label identification data to be used to create an industrial coordinate for an or the electronic label and/or to add it to the industrial coordinate system, and/or to assign an industrial coordinate to the electronic label. For example, the label identification data may comprise an industrial coordinate of an electronic label. Alternatively or additionally, the label identification data may comprise a message, instruction and/or control command, on the basis of which the management system can identify and/or determine an or the electronic label, can create an industrial coordinate for the electronic label and/or can add it to the industrial coordinate system, and/or on the basis of which the management system can create an or the instruction.

The part identifier and/or the part identification data may be used to identify and/or determine the good. Provision may also be made for the part identifier and/or the part identification data to be used to create an industrial coordinate for the good and/or to add it to the industrial coordinate system, and/or to assign an industrial coordinate to the good. For example, the part identifier and/or the part identification data may comprise an industrial coordinate of an or the good. Alternatively or additionally, the part identifier and/or the part identification data may comprise one or more physical properties of the good. Alternatively or additionally, the part identifier and/or the part identification data may comprise a message, instruction and/or control command, on the basis of which the management system can identify and/or determine the good, can create an industrial coordinate for the good and/or can add it to the industrial coordinate system, and/or on the basis of which the management system can create an or the instruction.

The good to be stored may be or comprise a component, a product, a starting material, a starting product, an intermediate product, a finished product, a finished part, a semi-finished product, or the like.

The management system may link and/or assign the goods to the electronic label. The management system may link and/or assign the respective industrial coordinates to one another.

The electronic label may be attached to the good. It may be provided that the attachment and/or attachment of the electronic label is attached to the good after the assignment and/or linking.

The electronic label may be scanned, and the mobile data acquisition device may transmit an acknowledgement to the management system. The storage of the goods may be acknowledged.

After the transmission of the acknowledgement the management system may change or delete an industrial coordinate linked to the acknowledgement, and/or newly create an industrial coordinate and link it to the acknowledgement. The state and/or status of the system, of the management system, and/or of the goods and/or products may thus be updated.

When acquiring the identifier the mobile data acquisition device may wirelessly acquire the identification data. It may be provided that the identification data may be automatically acquired by the mobile data acquisition device if a distance between identifier and mobile data acquisition distance is less than a minimum distance.

The mobile data acquisition device may be arranged, attached and/or attached to a transport unit. The identifier may be arranged, attached and/or attached to an object to be transported. The creation of the instruction may comprise determining a storage location, parking location and/or destination location of the object to be transported.

The industrial coordinate assigned to the object to be transported may not be comprised and/or not have the storage location, parking location and/or destination location before the acquisition of the identifier, the transmission of the information and/or the determination of the instruction. It may be provided that the management system may change the industrial coordinate linked to the object after the acquisition of the identifier and/or the transmission of the information and/or the determination of the instruction such that it may comprise the storage location, parking location and/or destination location.

Merely by way of example, an instruction may instruct a user and/or operator to perform an action and/or comprise and/or communicate an action instruction and/or action recommendation to the user and/or operator. Merely by way of example, an instruction may comprise a control command for a machine. These examples are not exhaustive.

Provision may be made for one or more steps of one, a plurality of or all of the methods described above to be carried out in a different and/or deviating order.

One, a plurality of or all steps of one, a plurality of or all of the methods described above may be computer-implemented.

A further aspect relates to a system, comprising a mobile data acquisition device, a management system, and a plurality of objects, wherein an industrial coordinate is assigned to each object, which industrial coordinates are structured with an industrial coordinate system, wherein the industrial coordinates comprise at least one hierarchy level and at least one, a plurality of or all hierarchy levels correspond to a physical property, preferably an installation location, a storage location, an operating mode, a clock, a machine type, a product and/or production information, of the object assigned to the respective industrial coordinate, wherein the system is configured to carry out one or the method described above.

At least two, a plurality of or all of the industrial coordinates may have at least one common hierarchy level. At least two, a plurality of or all of the industrial coordinates may have and/or comprise at least one different hierarchy level.

At least two, a plurality of or all of the industrial coordinates may have the same number of hierarchy levels. At least two, a plurality of or all of the industrial coordinates may have and/or comprise a different number of hierarchy levels.

### BRIEF DESCRIPTION OF THE DRAWINGS

The invention is explained further with reference to the following figures. In the figures:

FIG. 1: shows an exemplary embodiment of a management system according to the invention;

FIG. 2: shows an exemplary embodiment of an industrial coordinate system;

FIG. 3: shows another exemplary embodiment of an industrial coordinate system;

FIG. 4: shows a further exemplary embodiment of an industrial coordinate system;

FIG. 5: shows yet a further exemplary embodiment of an industrial coordinate system;

FIG. 6: shows an exemplary embodiment of a mobile data acquisition device and an identifier;

FIG. 7: shows another exemplary embodiment of a mobile data acquisition device and an identifier; and

FIG. 8: shows yet another exemplary embodiment of a mobile data acquisition device and an identifier.

### DESCRIPTION OF THE PREFERRED EMBODIMENTS OF THE INVENTION

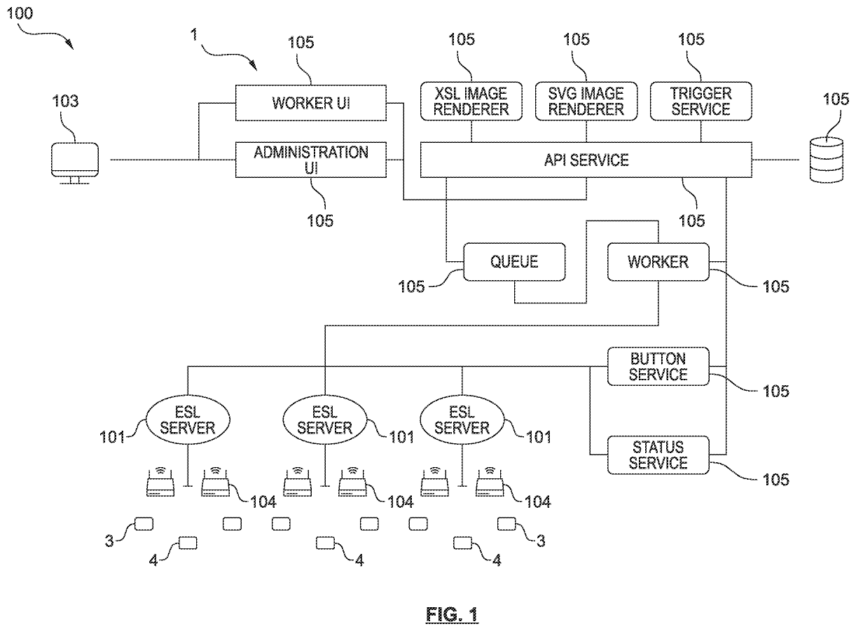

FIG. 1 shows an embodiment of a system 100 according to the invention. The system 100 has a management system 1. The system 100 has one or more mobile data acquisition devices 3 and one or more objects 4. The system 100 and/or the management system 1 may have one or more servers 101. Alternatively or additionally, the management system 1 may be connected to one or more servers 101 for data exchange. The system 100 and/or the management system 1 may have a database 102. Alternatively or additionally, the management system 1 may be connected to a database 102 for data exchange. The system 100 and/or the management system 1 may have one or more external devices 103. Alternatively or additionally, the management system 1 may be connected to one or more external devices 103 for data exchange. The system 100 and/or the management system 1 may have one or more communication units 104. Alternatively or additionally, the management system 1 may be connected to one or more communication units 104 for data exchange.

The management system 1 may have one or more components 105. One or the component 105 may comprise a software component and/or a software package. For example, a component may be and/or comprise a user interface, e.g. a GUI, a worker UI, an administration UI, an API, an API service, a graphics or image renderer, e.g. an XSL image renderer and/or an SVG image renderer, a queue, a trigger service, a worker, a button service and/or a status service.

The management system 1 may have one or more computer units. The management system 1 may be cloud-based. Alternatively or additionally, the management system 1 may be set up on-premise and/or locally. One or the method according to the invention may be at least partially computer-implemented.

Provision may be made for the management system 1 to be able to manage access rights and/or user rights. By way of example, a user and/or operator may have a user access and/or an account with which he can access the management system 1. Provision may be made, for example, for one, a plurality of or all industrial coordinates 5 to be inaccessible to at least one, a plurality of or all users, and/or for the user not to be or be able to be read, changed, deleted or manipulated. By way of example, a particular user may only have access to or access to industrial coordinates 5 which are enabled for him and/or are correspondingly assigned to his user rights.

Provision may likewise be made for machines, computers, production tools or the like connected to the management system 1 for data exchange to only have access to industrial coordinates which are enabled in each case. Provision may be made for access rights to be set up for machines, computers, production tools or the like connected to the management system 1 for data exchange. Machines, computers, production tools or the like connected to the management system 1 for data exchange may have a user access and/or an account.

The management system 1 and/or the industrial coordinate system 6 may thus in particular also enable the management of user rights and roles for people and machines. The corresponding rights and roles may be or be distributed, set up and/or changed for example on the basis of generated data (e.g. scans), analyses and/or machine learning processes. The corresponding rights and roles may be or be distributed, set up and/or changed for example on the industrial coordinates 5.

In some embodiments, provision may be made to optimize, on the basis of and/or on the basis of industrial coordinates 5, generated data (e.g. scans), analyses and/or machine learning processes, e.g. travel routes, e.g. of users, workers such as warehouse keepers, or other personnel, and/or processes and/or warehouses, e.g. stockkeeping, inventory, cycle times, transit times, work sequences, a sequence of processing steps or the like.

In some embodiments, the industrial coordinate system 6 and/or the industrial coordinates 5 may be analyzed and/or evaluated for this purpose, for example by means of machine learning.

The communication unit 104 may be set up to exchange data with one or more mobile data acquisition devices 3 and/or one or more objects 4. The communication unit 104 may receive messages, control commands, messages, instructions and/or information from and/or communicate to a mobile data acquisition device 3 and/or an object 4.

At least one object 4 may be or comprise a good, a component, a semi-finished product, an intermediate product, an end product, a starting material or the like. Alternatively or additionally, at least one object 4 may be or comprise a machine, production apparatus, transport unit or the like. Alternatively or additionally, at least one object 4 may be or comprise an electronic label 7.

Alternatively or additionally, the object 4 may be or comprise a tablet, a mobile device, a laptop, a smartphone or the like. In some embodiments, it may be provided, e.g., that the object may be or comprise a tablet, a mobile device, a laptop, a smartphone or the like or the like, and the transmitted instruction may comprise an instruction to a user and/or operator. For example, a picker may be instructed and/or instructed via the tablet to remove, transport and/or store one or more specific objects. For example, a worker may be instructed and/or instructed via the tablet to carry out one or more specific work steps and/or production steps. It may be provided that the object 4 may be identical to the mobile data acquisition device 3 and/or may correspond to the mobile data acquisition device 3.

It may be provided that an order, a work instruction or the like may be transmitted to a user, e.g., a picker, work, warehouse worker or the like, such that the order may be transmitted to the mobile data acquisition device 3 or a mobile device of the user, e.g., a tablet or the tablet. For example, the order and/or the work instruction may be created, managed and/or transmitted by the management system 1 to the mobile data acquisition device 3 or the mobile device. The user may then execute the order, for example by carrying out a method according to the invention. Alternatively or additionally, an order, a work instruction or the like may be started and/or initiated by the user, for example by carrying out a method according to the invention. It may be provided that the user detects and/or scans an order slip, running slip, instruction or the like with a mobile device and/or the mobile data acquisition device 3. The order and/or the work instruction may be displayed to the user, e.g., after detection and/or scanning.

The order and/or the work instruction may be or comprise, for example, a work instruction for picking one or more goods and/or objects, e.g., pick-to-light and/or put-to-light, one or more work steps, e.g., assembly step, disassembly step, production instruction, transport instruction or the like. The order and/or the work instruction may completely or partially comprise a production, a production, a transport, a storage or removal, an assembly, a disassembly, or the like, and/or corresponding methods.

It may be provided that a or the data transmission between mobile data acquisition device 3 and communication unit 104, between data acquisition device 3 and management system 1, between object 4 and communication unit 104, and/or between object 4 and management system 1 may take place wirelessly. The data transmission may take place, for example, via a suitable low power wide area network, narrowband IOT, Bluetooth, ZigBee, Z-Wave, ANT+, LTE, or the like, and/or WiFi, WLAN, and/or other suitable protocols. Alternatively or additionally, a wired data transmission may also be provided.

Mobile data acquisition device 3 may be or comprise a handheld device. Mobile data acquisition device 3 may be or comprise a smartphone, tablet, laptop or the like. Mobile data acquisition device 3 may be or comprise a handheld scanner. Mobile data acquisition device 3 may be or comprise a functional glove. The functional glove may comprise a scanner.

It may be provided that mobile data acquisition device 3 may optically acquire an or the identifier 2, e.g. by scanning. For example, mobile data acquisition device 3 may comprise a suitable optical unit, e.g. a camera or the like. Alternatively or additionally, an identifier 2 and/or information may be or be acquired by mobile data acquisition device 3 via RFID, NFC, wirelessly, electromagnetically or the like. Identifier 2 and mobile data acquisition device 3 may be suitably set up. Identifier 2 may comprise e.g. a transmitter, and mobile data acquisition device 3 may comprise a receiver.

It may be provided that mobile data acquisition device 3 may comprise a display 14. In some embodiments, mobile data acquisition device 3 may comprise a computer unit. It may be provided that mobile data acquisition device 3 may execute an app or software via which an operator and/or user may transmit control commands to management system 1. In some embodiments, the sequence and/or one, a plurality of or all steps of the method may be controlled, monitored, initiated, stopped, aborted, resumed, confirmed and/or the like by one or more control commands. It may be provided e.g. that the user and/or operator may initiate the acquisition of identifier 2 by a control command.

In some embodiments, for example, a user and/or operator may initiate a picking of one or more goods, and/or objects, by a control command. In some embodiments, a picking may also be initiated without an explicit control command of the user and/or operator, and/or may take place automatically, for example according to predefined rules or upon fulfillment of predefined conditions. Mobile data acquisition device 3 may communicate to management system 1 that a good is to be picked. This message and/or instruction may for example be communicated with the acquired information to management system 1. Alternatively or additionally, the message and/or instruction may also be transmitted before and/or after the acquisition, and/or transmission of the information, from mobile data acquisition device 3 to management system 1. Management system 1 may process the transmitted information and/or averaging, for example change, adapt, delete and/or newly create one or more industrial coordinates 5, identify one or more objects 4 and/or create one or more instructions.

In some embodiments, for example, a user and/or operator may initiate a storage of one or more goods, and/or objects, by a control command. In some embodiments, a storage may also be initiated without an explicit control command of the user and/or operator, and/or may take place automatically, for example according to predefined rules or upon fulfillment of predefined conditions. Mobile data acquisition device 3 may communicate to management system 1 that a good is to be stored. This message and/or instruction may for example be communicated with the acquired information to management system 1. Alternatively or additionally, the message and/or instruction may also be transmitted before and/or after the acquisition, and/or transmission of the information, from mobile data acquisition device 3 to management system 1. Management system 1 may process the transmitted information and/or averaging, for example change, adapt, delete and/or newly create one or more industrial coordinates 5, identify one or more objects 4 and/or create one or more instructions.

In some embodiments, for example, a user and/or operator may initiate a transport of one or more goods by a control command. In some embodiments, a transport may also be initiated without an explicit control command of the user and/or operator, and/or may take place automatically, for example according to predefined rules or upon fulfillment of predefined conditions. Mobile data acquisition device 3 may communicate to management system 1 that a good is to be stored. This message and/or instruction may for example be communicated with the acquired information to management system 1. Alternatively or additionally, the message and/or instruction may also be transmitted before and/or after the acquisition, and/or transmission of the information, from mobile data acquisition device 3 to management system 1. Management system 1 may process the transmitted information and/or averaging, for example change, adapt, delete and/or newly create one or more industrial coordinates 5, identify one or more objects 4 and/or create one or more instructions.

The invention is not absolutely limited to picking, storing and/or transporting goods and/or objects. The invention can also be used in production systems. For example, a fitter and/or worker who is to assemble and/or manufacture a product may have suitable production steps, assembly steps and/or assembly instructions displayed by acquiring identifiers 2, for example on suitable screens arranged in the assembly area. For example, a fitter and/or worker may have properties of components and/or a product to be manufactured, and/or process steps displayed after scanning and/or acquiring an identifier.

The mobile data acquisition device 3 may have a communication interface, e.g. a radio interface, via which the mobile data acquisition device 3 can exchange data with the management system 1, e.g. via communication unit 104.

The database 102 may store the industrial coordinate system 6, and/or industrial coordinates 5, for example. It may be provided that properties and/or data of objects 4 are stored and/or stored in the database 102.

The external device 103 may be or comprise a computer device. The external device 103 may query, acquire, determine and/or analyze a state and/or status of the management system 1 and/or of the system 100. Provision may be made for the external device 103 to be able to access the industrial coordinate system 6. In some embodiments, the external device 3 may change the industrial coordinate system 6, for example change, add or remove an industrial coordinate 5. Provision may be made for the external device 103 to be able to transmit a control command, an instruction and/or a message to the management system 1.

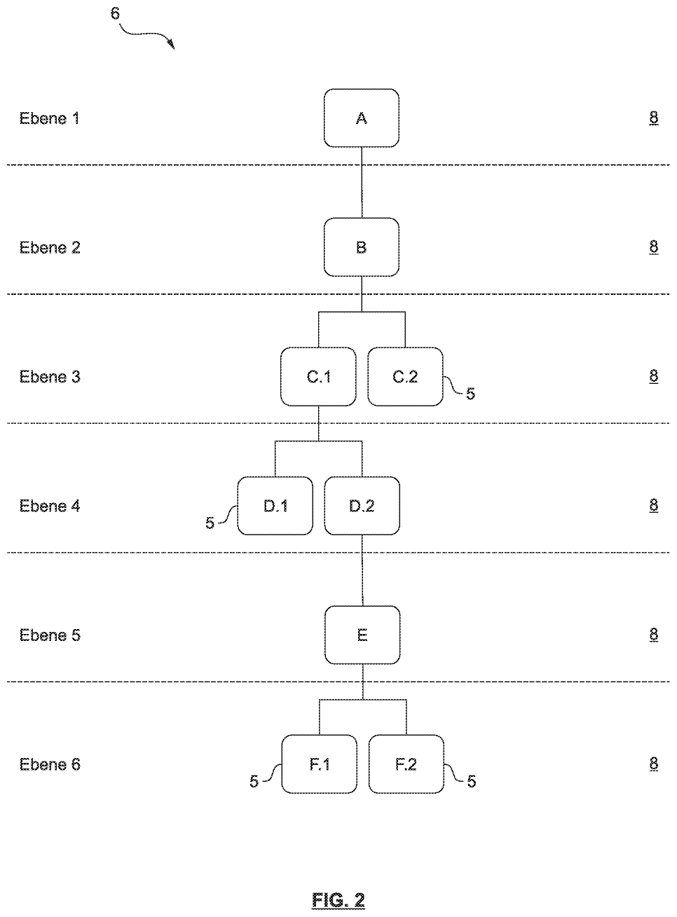

FIGS. 2, 3, 4 and 5 show exemplary industrial coordinate systems 6. The industrial coordinate system 6 may have a hierarchical structure and/or a tree structure. The industrial coordinate system 6 and/or an industrial coordinate 5 may have one or more hierarchy levels 8. Even if the figures each show six hierarchy levels 8 (which are denoted by “level 1” to “level 6” in the figures), the industrial coordinate system 6 may also have, specify and/or structure fewer than six hierarchy levels 8 or more than six hierarchy levels 8. An industrial coordinate 5 may be defined by means of the industrial coordinate system 6. The industrial coordinate system 6 may define, structure and/or manage one or more industrial coordinates 5. The industrial coordinate system 6 and/or the industrial coordinate 5 may have a hierarchical and/or tree-shaped structure and/or a hierarchical and/or tree-shaped structure.

The industrial coordinate system 6 and/or the industrial coordinates 5 may have a tree-shaped structure. The industrial coordinates 5 may be at least partially grouped.

An industrial coordinate 5 may consist of a plurality of constituents and/or have a plurality of constituents. In some embodiments, an industrial coordinate 5 may have one constituent per hierarchy level 8 of the industrial coordinate system 6. At least one industrial coordinate 5 may have one constituent in a hierarchy level 8 and/or comprise a hierarchy level 8 in which at least one other industrial coordinate 5 has no constituent and/or is not comprised by the other industrial coordinate 5. Provision may also be made for the industrial coordinate system 6 to have a number of hierarchy levels 8, and at least one industrial coordinate 5 to comprise or consist of a number of constituents smaller than the number of hierarchy levels 8 of the industrial coordinate system 6. In other words, an industrial coordinate 5 does not absolutely have to have or comprise one constituent for each hierarchy level 8 of the industrial coordinate system 6. If an industrial coordinate 5 has one constituent in a hierarchy level 8, and/or one constituent assigned to a hierarchy level 8, the industrial coordinate 5 may comprise the corresponding hierarchy level 8. One, a plurality of or all industrial coordinates 5 may be or have an alphanumeric string and/or an alphanumeric character string.

Provision may be made for a physical property to be assigned to at least one hierarchy level 8. In particular, provision may also be made for a physical property to be assigned to each hierarchy level 8. An industrial coordinate 5 of an object 4 may have a constituent of the corresponding hierarchy level 8 if the object 4 has the corresponding physical property.

Provision may be made for a physical property to be assigned to at least one constituent of an industrial coordinate 5. In particular, provision may also be made for a physical property to be assigned to each constituent of an industrial coordinate 5.

Provision may be made for a hierarchy level 8 to map and/or represent a physical property, and for a constituent of the hierarchy level 8 to represent and/or map a value of the corresponding physical property.

For example, a hierarchy level 8 may represent a location specification and/or a position specification of a corresponding object 4, and a constituent of the corresponding hierarchy level 8 of an industrial coordinate 5 may represent the actual location and/or the actual position of the object 4, for example a continent, a country, a city and/or region, an installation location, a storage location, a factory hall, an assembly table, or the like. For example, a constituent may have, map, represent, comprise, or the like a position coordinate, e.g. a degree of longitude and/or a degree of latitude.

For example, a hierarchy level 8 may represent a quantity specification of a corresponding object 4, and a constituent of the corresponding hierarchy level 8 of an industrial coordinate 5 may represent the actual number and/or quantity of the object 4, for example “2”, “two”, “7358”, “twenty-three hundred four” or the like.

For example, a hierarchy level 8 may represent a machine type during the production of the corresponding object 4, and a constituent of the corresponding hierarchy level 8 of an industrial coordinate 5 may represent the machine actually used during the production or production of the object 4, for example “milling machine 15”, “conveyor belt C-7A3”, or e.g. a model number such as e.g. “X423AB”.

For example, a hierarchy level 8 may represent a part number of a corresponding object 4, and a constituent of the corresponding hierarchy level 8 of an industrial coordinate 5 may represent the actual part number of the object 4.

For example, a hierarchy level 8 may represent a type of a component or good of a corresponding object 4, and a constituent of the corresponding hierarchy level 8 of an industrial coordinate 5 may represent the actual component or good. For example, a hierarchy level 8 may define that the component and/or the good is a gear wheel, a spring, a fabric web, a screw, a container, a tray, a semi-finished product and/or the like, and a constituent may represent and/or map for example a product designation of the corresponding component and/or the corresponding good, a type number, a value characteristic of the component and/or the good or the like.

In some embodiments, an industrial coordinate 5 may comprise e.g. a type of an object, a storage location and a quantity of the objects stored at the storage location. If a number of objects is removed, e.g. one or more than one, the corresponding industrial coordinate 5 may be changed e.g. such that the constituent representing the number is changed such that it represents the number of objects present after the removal at, in or at the storage location, for example may be or will be reduced by the number of removed objects. For example, one or more new industrial coordinates 5 may be generated and/or created for the removed object or objects. If more than one object is removed, provision may be made for exactly one new industrial coordinate 5 to be created and/or generated, wherein a constituent of the new industrial coordinate 5 may comprise the number of removed objects. However, provision may also be made for a separate industrial coordinate 5 to be created and/or generated for each removed object, and/or for at least two industrial coordinates 5 to be created and/or generated, which each comprise and/or represent at least one or more removed objects.

In some embodiments, an industrial coordinate 5 may comprise e.g. a type of an object, a storage location and a quantity of the objects stored at the storage location. If a number of objects is stored and/or deposited, e.g. one or more than one, the corresponding industrial coordinate 5 may be changed e.g. such that the constituent representing the number is changed such that it represents the number of objects present after the storage and/or deposition at, in or at the storage location, for example may be or will be increased by the number of removed objects. One or more industrial coordinates 5 assigned to the deposited and/or stored object or objects may be deleted and/or removed. These are merely non-exhaustive examples. For example, a constituent of an industrial coordinate 5 may represent, comprise, map and/or represent a value or a specification of a physical property.

The exemplary constituents “A”, “B.1”, etc. of the industrial coordinates 5 in the following FIGS. 2, 3, 4 and 5 are named only schematically in the figures for abstraction reasons. However, provision may be made in particular according to the invention for the constituents to be named in such a way that the physical property of the corresponding object 4 represented thereby is directly visible. Merely by way of example, an industrial coordinate 5 may be “Europa_Deutschland_München_Standort1_Halle5_Lager3_Reihe17_Fach5_Zahnrad_Zahnung32_Anzahl15”, or “E_DE_M_1_5_3_17_5_Z_32_15”, or e.g. “US_NY_Halle5_Maschine3”. Provision may be made for the industrial coordinates 5 and/or the constituents thereof to be selected in such a way that they can be interpreted for a human being directly as the corresponding physical property. A comparability and verifiability of the industrial coordinates 5 or of the assigned objects 4 can thus be further increased.

The exemplary separation signs or separations of the constituents by underscores, “_”, are merely exemplary. Other separation signs are also possible, for example, but not exhaustive, semicola “;”, dots “.”, commas “,”, hyphens or minus signs “−”, or the like.

Even if the exemplary constituents “A”, “B.1”, etc. of the industrial coordinates 5 are named only abstractly, these may correspond to physical properties and/or physical values of the assigned object 4. For example, a dictionary or a list may be provided which maps and/or assigns the abstract names unambiguously to physical properties and/or physical values. In some embodiments, for example, correspondence lists, equivalence lists, dictionaries, mappings, assignments or the like may be provided.

The number of physical properties mapped and/or represented in an industrial coordinate 5 may deviate from the number of real physical properties of the assigned (real) object 4. In particular, the number of physical properties mapped and/or represented in an industrial coordinate 5 may be less than the number of real physical properties of the assigned (real) object 4. It is not absolutely necessary for the industrial coordinate system 6 and/or an industrial coordinate 5 to map and/or represent all actual physical properties and/or physical values of a real object 4 assigned to an industrial coordinate 5.

In the exemplary embodiment shown in FIG. 2, for example, a first industrial coordinate 5 may be defined by A_B_C.1_D.1. Depending on the definition of the hierarchy levels 8, this exemplary first industrial coordinate 5 may thus map, for example, one, two, three or four physical properties of an object 4 assigned to the first industrial coordinate 5. In some embodiments, this exemplary first industrial coordinate 5 may map four physical properties of an object 4 assigned to the first industrial coordinate 5. The assigned object 4 may be uniquely determined by the first industrial coordinate 5.

In the exemplary embodiment shown in FIG. 2, for example, a second industrial coordinate 5 may be defined by A_B_C.2. The second industrial coordinate 5 may be assigned to a second object 4, and/or may uniquely identify and/or correspond to a second object 4 assigned to the industrial coordinate 5.

In the exemplary embodiment shown in FIG. 2, for example, a third industrial coordinate 5 may be defined by A_B_C.1_D.2_E_F.1. A fourth industrial coordinate 5 may be defined by A_B_C.1_D.2_E_F.2. A third object 4 may uniquely correspond to and/or be mapped to the third industrial coordinate 5, and/or may be identified and/or determined by the latter. A fourth object 4 may uniquely correspond to and/or be mapped to the fourth industrial coordinate 5, and/or may be identified and/or determined by the latter.

In the exemplary embodiment shown in FIG. 2, the first object 4, the second object 4, the third object 4 and the fourth object 4 may have the same physical properties A and/or B. However, the respective objects 4 may differ in further physical properties.

For example, the second object 4 may have the same first physical property A and the same second physical property B as the first object 4. However, the second object 4 may have a physical property C. 2, which may be different from the physical properties C. 1 and D. 1 of the first object 4. For example, the first object 4 and the second object 4 may be stored and/or stored in the same storage hall (e.g. mapped and/or represented by the constituents “A” and “B” of the respective levels 1 and 2), but at different locations in the same storage hall (e.g. mapped and/or represented by the constituents “C. 1” and “C. 2” of the level 3). The industrial coordinate 5 of the first object 4 may also map e.g. a physical property which is missing from the second object 4 or which is at least not relevant to the second object 4. For example, the first object 4 may be mapped as a component type corresponding to “C. 1” (e.g. “spur gear 15-8” or the like), and the first object 4 may be or comprise a spur gear. The level 4 may thus correspond for example to the type “spur gear”, and the constituent “D. 1” may correspond to the type number or type designation (e.g. “spur gear 15A-8”, or e.g. only “15A-8”). By contrast, the second object 4 may not be or comprise a spur gear, such that the industrial coordinate 5 of the second object 4 may e.g. have no constituent in the level 4.

For example, the third object 4 and the fourth object 4 may be stored and/or stored at the same location in the same storage hall as the first object 4 (“A”, “B” and “C.1” or “A_B_C.1”), as mapped and/or represented by the same constituents of the level 1, the level 2 and the level 3. For example, the third object 4 and the fourth object 4 may be or comprise spur gears, but of a type different from the first object 4, such that the industrial coordinates 5 of the third object 4 and of the fourth object 4 may have a constituent in the level 4 (“D. 2”), but which may differ from the constituent of the industrial coordinate 5 of the first object (“D. 1”). For example, the third object 4 and the fourth object 4 may correspond to a spur gear of the type number or type designation (e.g. “spur gear 17B-10”, or e.g. only “17B-10”).

For example, the third object 4 and the fourth object 4 may be produced by the same machine and/or the same production process. For example, the level 5 may map and/or represent a machine type and/or production process, and the constituent E of the industrial coordinates 5 may map the actual machine or the name thereof, and/or may designate the specific production process. For example, the third object 3 and the fourth object 4 may be milled, and/or may have been produced with a milling machine. For example, the third object 3 and the fourth object 4 may have been produced by the specific milling machine “F10.2.5”. The constituent (“E”) of the industrial coordinates 5 of the third object 3 and of the fourth object 4 may correspondingly represent and/or map a milling machine and/or milling machine “F10.2.5”.

For example, the third object 4 and the fourth object 4 may differ in that the third object 4 is provided for installation in a vehicle transmission and/or is stored and/or stored, whereas the fourth object 4 is provided as a replacement part for a compressor. For example, level 6 may map or represent a purpose of use, and the constituent of the level 6 of the respective industrial coordinates may map and/or represent the actual use. Alternatively, the third object 4 and the fourth object 4 may differ in that the third object 4 is nitrided, whereas the fourth object 4 is not nitrided. For example, level 6 may map or represent a nitriding, and the constituent of the level 6 of the respective industrial coordinates may map and/or represent the presence of a nitriding (e.g. “Yes”, “No”, “1”, “0”).

The examples described above are merely exemplary. The industrial coordinate system 6, the industrial coordinates 5 and/or the objects 4 are not limited thereto. The industrial coordinate system 6 and the industrial coordinates 5 can be used flexibly for a multiplicity of different objects 4.

Industrial coordinates 5 may simply and uncomplicatedly be added to the industrial coordinate system 6. New industrial coordinates 5 may simply and uncomplicatedly be created.

If, for example, an industrial coordinate 5 having the constituents or the correspondingly represented physical properties “A_B_C.1_D.3” is to be added to the industrial coordinate system 6 shown in FIG. 2, a further edge, link and/or connection to a new node or constituent D.3 may be added starting from the node or constituent C.1 in the industrial coordinate system 6. In order to remain in the example described above with reference to FIG. 2, for example a fifth industrial coordinate 5, which maps or represents a fifth object 4, which may be stored and/or stored at the same location in the same storage hall as the first, third and fourth object 4 (“A”, “B” and “C.1” or “A_B_C.1”) and which may be a spur gear having the type designation “XAB” (corresponding to “D.3”), may simply and uncomplicatedly be created and/or added in the industrial coordinate system 6.

If, for example, the first industrial coordinate 5 (“A_B_C.1_D.1”) is to be removed and/or deleted from the industrial coordinate system 6 shown in FIG. 2, for example because or when the first object 4 is removed from the system or has left the system, the node or constituent D.1 may be deleted and/or removed, and/or the corresponding edge or connection may be removed or deleted.

Accordingly, industrial coordinates 5 may simply and uncomplicatedly be added or removed simply and uncomplicatedly. In addition, little effort, computing effort and/or little computer operations may be necessary for the addition and/or removal.

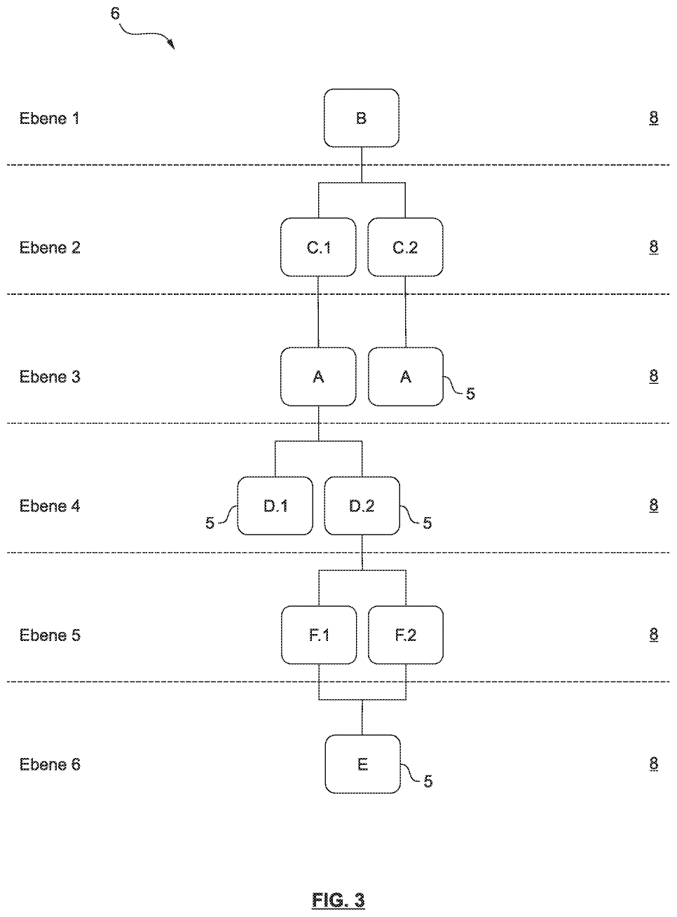

The assignment to the planes 6, and/or the physical properties represented by the planes 6, are not limited to those described. One, a plurality of or all planes 6 may alternatively or additionally be arranged differently, such that a different tree structure may result for the same physical properties or the same objects 4, and/or the corresponding industrial coordinates 5 may be correspondingly differently formed and/or structured. By way of example, FIG. 3 shows an industrial coordinate system 6 different from that in FIG. 2, in which the same objects 4, i.e. the first object 4, the second object 4, the third object 4 and the fourth object 4, may be mapped or represented with the same physical properties and corresponding industrial coordinates 5.

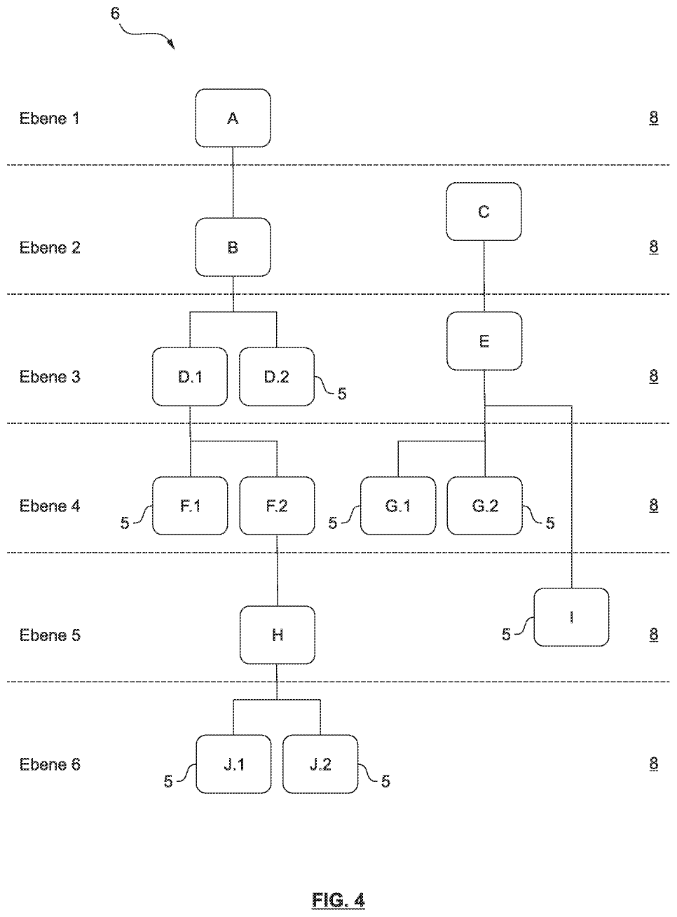

In the exemplary embodiment shown in FIG. 4, a first industrial coordinate 5 may be determined and/or defined by A_B_D.2, a second industrial coordinate 5 by A_B_D.1_F.1, a third industrial coordinate 5 by A_B_D.1_F.2_H_J.1, a fourth industrial coordinate 5 by A_B_D.1_F.2_H_J.2, a fifth industrial coordinate 5 by C_E_G.1, a sixth industrial coordinate 5 by C_E_G.2 and/or a seventh industrial coordinate 5 by C_E_I. Objects 4 may correspondingly be uniquely assigned to the respective industrial coordinates 5. Provision may be made for at least two industrial coordinates 5 of the industrial coordinate system 6 to have no common constituents (cf. e.g. “A_B_D.1_F.1” and “C_E_G.1” in FIG. 4). Provision may be made for at least one industrial coordinate 5 to have constituents which do not have to be assigned to directly adjacent planes (cf. e.g. “C_E_I” in FIG. 4). Provision may be made for at least one industrial coordinate 5 not to comprise a respective constituent on or for each hierarchy level 8 of the industrial coordinate system 6.

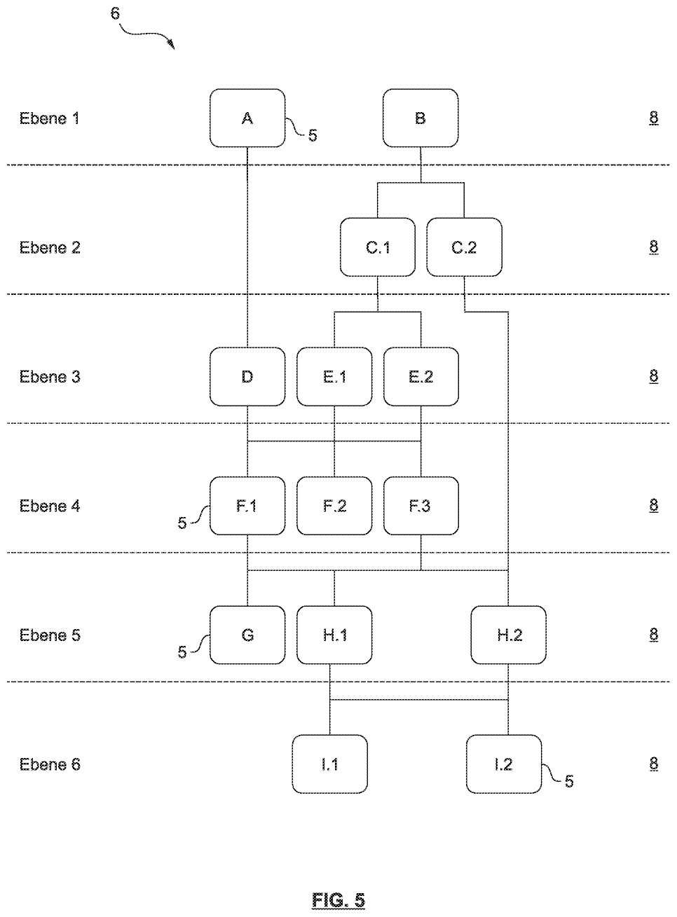

In the exemplary embodiment shown in FIG. 5, a multiplicity of industrial coordinates 5 may be provided in the industrial coordinate system 6 shown by way of example. For example, the exemplary embodiment shown in FIG. 5 may comprise fifty-one industrial coordinates 5. As can be identified in particular in FIG. 5, the industrial coordinates 5 may be grouped. The memory requirements may thus be reduced. In addition, an access time and/or retrieval time may be reduced.

At least one, a plurality of or all hierarchy levels 8 correspond to a physical property of an object 4, and/or represent and/or map a physical property, such that objects 4 or the corresponding industrial coordinates 5 thereof may simply be grouped and/or linked in the industrial coordinate system.

In addition, the objects 4 and the industrial coordinates 5 assigned thereto may simply be verified, since the physical properties of the (real) objects 4 can be easily and simply checked and compared with the corresponding hierarchy levels 8 (levels 1 to 6 in the figures) and/or the industrial coordinates 5, and/or the constituents (“A”, “B.1”, etc.) of the industrial coordinates 5.

By virtue of the fact that at least one, a plurality of or all hierarchy levels 8 correspond to a physical property of an object 4, and/or represent and/or map a physical property, and correspondingly the objects 4 may simply be grouped and/or linked in the industrial coordinate system, new industrial coordinates 5 may simply and uncomplicatedly be inserted. By virtue of the fact that the industrial coordinate system 6 may have a tree-shaped structure, the industrial coordinates 5 may be grouped and/or linked, and new industrial coordinates 5 may simply and uncomplicatedly be inserted. By virtue of the grouping, memory requirements may be reduced. By virtue of the grouping, an access time and/or retrieval time of the industrial coordinates 5 may be reduced. For example, grouped industrial coordinates 5 may be stored close to one another in a memory.

By virtue of the fact that at least one, a plurality of or all hierarchy levels 8 correspond to a physical property of an object 4, and/or represent and/or map a physical property, a status of the system 100, of the management system 1, and/or of the goods and/or products may already be determined and/or ascertained by the industrial coordinate system 6. In particular, a downstream analysis or evaluation of a status of the system 100, of the management system 1, and/or of the goods and/or products may be significantly accelerated, or even a downstream analysis or evaluation may be dispensed with. Provision may be made for the industrial coordinate system to itself already map and/or represent the status.

Provision may be made for at least one industrial coordinate 5 to be monitored, checked and/or verified in an ongoing, in-turn and/or periodic manner. Provision may be made for at least one industrial coordinate 5 to be updated in an ongoing, in-turn and/or periodic manner. By virtue of the updating, for example, the actual state of an object 4 may be brought into agreement or agreement with that mapped and/or represented by the corresponding industrial coordinate 5.

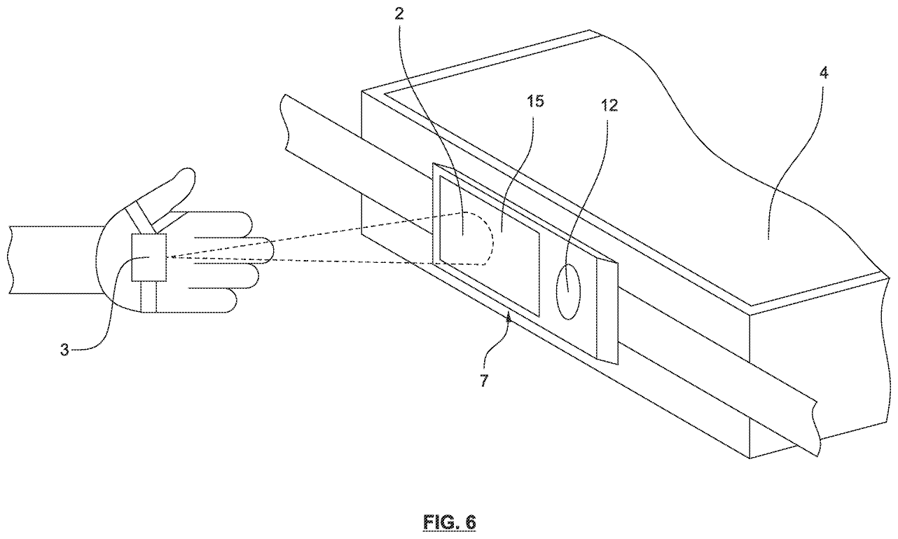

FIG. 6 shows an exemplary embodiment of a mobile data acquisition device 3 and an identifier 2. Mobile data acquisition device 3 may be or comprise a handheld scanner. Mobile data acquisition device 3 may be or comprise a functional glove. The functional glove may comprise a scanner. In some embodiments, mobile data acquisition device 3 may be or comprise a smartphone, a tablet or the like.

Mobile data acquisition device 3 may be set up to acquire and/or scan identifier 2. During the acquisition and/or scanning of identifier 2, information stored and/or coded in identifier 2 may be or may be read out.

Identifier 2 may be or comprise, for example, a QR code, a barcode, an alphanumeric code, a pictogram or the like.

In some embodiments, identifier 2 may be or comprise an electronic label 7. In some embodiments, an electronic label 7 may represent, display and/or map identifier 2. Electronic label 7 may comprise a display 15. Display 15 may be or comprise an e-ink display. Electronic label 7 may comprise a lighting unit 12. Lighting unit 12 may be or comprise an LED. Alternatively or additionally, identifier 2 may be or comprise a tablet or the like, and/or may be or be displayed by a tablet or the like.

An object 4 may be assigned to identifier 2. For example, one or industrial coordinate 5 of object 4 may be linked and/or assigned to identifier 2. In some embodiments, industrial coordinate 5 of object 4 may be stored and/or coded in identifier 2 as information, or as part of information.

One or the method according to the invention may first comprise acquiring identifier 2 with mobile data acquisition device 3. Mobile data acquisition device 3 may acquire information stored in identifier 2. The information may then be transmitted to management system 1 connected to mobile data acquisition device 3 for data exchange. Management system 3 may identify at least one object 4 of a plurality of objects 4. A unique industrial coordinate 6 of industrial coordinate system 6 may be assigned to each object 4. During the identification, unique industrial coordinate 5 of object 4 to be identified may be determined on the basis of the transmitted information. For example, the transmitted information may be at least partially compared with industrial coordinates 5 of industrial coordinate system 6 uniquely assigned to the respective objects 4.

Management system 1 may create an instruction on the basis of the identified object 4, the industrial coordinates 5 thereof and/or the transmitted information. The instruction may be transmitted from management system 1 to mobile data acquisition device 3, the identified object 4 and/or to an external device, e.g., external device 103, connected to management system 1 for data exchange.

The method according to the present invention may be suitable and/or set up and/or used, for example, for managing a storage system, a goods system and/or a production system.

Provision may be made for the acquired and/or transmitted information to comprise one or more control commands, instructions and/or messages to the management system.

In some specific embodiments, auxiliary information may be transmitted when transmitting the information. The auxiliary information may be acquired and/or determined, for example, when acquiring the information. For example, the auxiliary information may comprise and/or map a physical property of an object 4. Alternatively or additionally, the auxiliary information may comprise, for example, a location and/or a position of identifier 2, an object 4 and/or mobile data acquisition device 3. When identifying object 4, the identification, preferably one or the matching, may take place taking into account the auxiliary information. The identification of object 4 may be and/or be facilitated by the auxiliary information. For example, on the basis of and/or based on the auxiliary information, an identification, a search and/or a delimitation of one or more industrial coordinates 5 of industrial coordinate system 6 may be or may be facilitated and/or accelerated.

In some embodiments, provision may be made for the user and/or operator to input, determine and/or determine auxiliary information in or with mobile data acquisition device 3. For example, one or the app may be used to input the auxiliary information. For example, mobile data acquisition device 3 may be set up to automatically determine some, several or all auxiliary information, for example via suitable sensors. For example, mobile data acquisition device 3 may comprise a position sensor.

In some embodiments, one or the method may be suitable and/or used for picking goods, for example for a “pick-to-light” method.

Provision may be made for identifier 2 to be or to comprise an order slip. The order slip may comprise information relating to one or more goods to be picked. These may be or may be read out and/or acquired during the acquisition of identifier 2, for example by scanning.

The good may be or comprise a component, a starting material, an intermediate product, a component, a semi-finished product, a replacement part, a finished product, and/or the like.

In some embodiments, the information may comprise, for example, one or more industrial coordinates 5 of the good to be picked, and/or storage locations, number, or at least features which are suitable for identifying the good to be picked, and/or an electronic label 7 assigned to and/or corresponding to the good to be picked. During or after the transmission of the information, management system 1 may determine and/or determine the good to be picked and/or its assigned industrial coordinate 5. In some embodiments, management system 1 may alternatively or additionally determine and/or determine a container and/or storage location of the good to be picked. In some embodiments, management system 1 may, for example, identify and/or determine an electronic label 7. Provision may be made for management system 1 to identify, determine and/or determine one or industrial coordinate 5 of a corresponding electronic label 7 based on the transmitted information. Electronic label 7 may be arranged at or at a storage location of the good to be picked, for example a compartment, a container, a storage shelf or the like. In some embodiments, electronic label 7 may also be arranged directly on the good to be picked.

Management system 1 may create an instruction which may, for example, instruct electronic label 7 to light up and/or to flash. The instruction may be transmitted to electronic label 7 so that electronic label 7 may light up and/or flash after receiving the instruction. Electronic label 7 may, for example, comprise a lighting unit 12, e.g. an LED or a lamp. Alternatively or additionally, if electronic label 7 comprises a display 15, display 15 may light up and/or flash.

Lighting unit 12, e.g. LED, and/or electronic label 7 may be configured to flash and/or light up in different colours. Provision may be made for colour and/or frequency to be varied, selected and/or predefined. For example, the colour and/or the frequency may be selected and/or predefined to the user, e.g. user account or the like, an object to be picked or the like, depending on the industrial coordinate, the identified object and/or e.g. a location, for example a container, compartment, a storage shelf, one or the like, from which an object is to be or is to be removed and/or deposited. In some embodiments, the predefined colour and/or frequency may be part of the instruction transmitted by management system 1.

In some embodiments, the colour and/or frequency may be selected, predefined and/or varied such that instructions, commands and/or information may be transmitted to a user, e.g., a picker and/or warehouse worker, which may be based on and/or correspond to the colour and/or frequency, for example. In some embodiments, provision may be made for a specific colour and/or frequency to be assigned to at least one, more or all users, e.g., pickers and/or warehouse workers, and/or user accounts. The colour and/or frequency may be user-specific, e.g. picker-specific.

In some embodiments, provision may be made for an operator and/or user to then pick the good to be picked. If the good to be picked is stored and/or arranged, for example, in a compartment, a container and/or a storage shelf, the operator and/or the user may remove the good to be picked.

Provision may be made for the operator and/or the user to acknowledge the picking, e.g., a removal. For example, an identifier 2 of the electronic label may be or may be acquired, and the information read out with it may be or may be transmitted to management system 1.

Management system 1 may then adapt, change and/or delete one or more industrial coordinates 5. For example, management system 1 may adapt and/or change one or more industrial coordinates 5 such that they correspond to the physical properties of object 4 present after the picking, e.g., the picked good and/or a container or storage location.

For example, management system 1 may change an industrial coordinate 5 assigned to a storage location such that industrial coordinate 5 may comprise a correspondingly changed number of goods. For example, management system 1 may change an industrial coordinate 5 assigned to the good such that its state and/or location may correspond to the picked good.

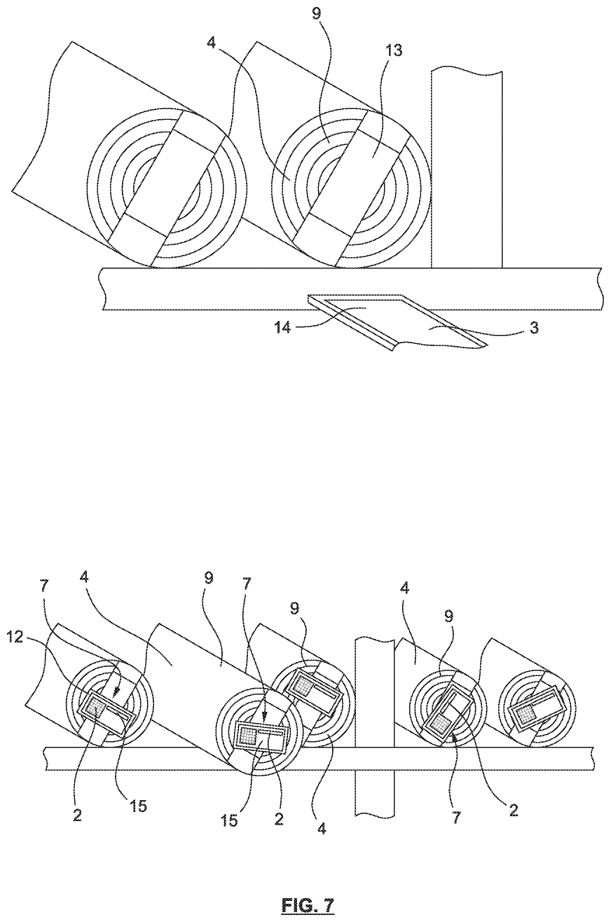

FIG. 7 shows a further exemplary embodiment of a mobile data acquisition device 3 and an identifier 2.

In some embodiments, one or the method according to the invention may be suitable and/or used for storing goods, for example for a “put-to-light” method.

One or the method may assign an industrial coordinate 5 to industrial coordinate system 6, and/or create a new industrial coordinate 5.

The method may, e.g., for assigning an industrial coordinate 5 to industrial coordinate system 6 and/or for creating a new industrial coordinate 5, comprise acquiring a part identifier 13 of a good 9 to be stored with a or the mobile data acquisition device 3. The part identification data of part identifier 13 may be acquired by mobile data acquisition device 3. Part identifier 13 may, for example, be arranged and/or attached on or at the good 9 to be stored. Alternatively or additionally, a separate part identifier 13, for example a list or the like, may be provided.

The part identification data may be transmitted to the management system 1 connected to the mobile data acquisition device 3 for data exchange.

An electronic label 7 may be acquired with the mobile data acquisition device 3. Label identification data of the electronic label 7 may be acquired.

The label identification data may be transmitted to the management system 1 connected to the mobile data acquisition device 3 for data exchange.

The management system 1 may create an industrial coordinate 5, which may be assigned to the electronic label 7 and/or the product 9. The industrial coordinate 5 may be created on the basis of the part identification data and/or the label identification data. Alternatively or additionally, an industrial coordinate 5 of the product 9 may be created, which is assigned and/or linked to an industrial coordinate 5 of the electronic label 7, which may already be present or which may also be newly created.

For example, the part identification data may comprise physical properties of the product 9. The physical properties of the product 9 stored, present and/or coded in the part identification data may be used to create the industrial coordinate 5, e.g., the industrial coordinate 5 of the product 9.

Alternatively or additionally, the part identifier 13 and/or the part identification data may be used to identify and/or determine the product 9. Provision may also be made for the part identifier 13 and/or the part identification data to be used to create an industrial coordinate 5 for the product 9 and/or to add it to the industrial coordinate system 6, and/or to assign an industrial coordinate 5 to the product 9. For example, the part identifier 13 and/or the part identification data may comprise an industrial coordinate 5 of an or the product. Alternatively or additionally, the part identifier and/or the part identification data may comprise a message, instruction and/or control command, on the basis of which the management system 1 can identify and/or determine the product 9, can create an industrial coordinate 5 for the product 9 and/or can add it to the industrial coordinate system 6, and/or on the basis of which the management system 1 can create an or the instruction.

The label identification data may be used to identify and/or determine an electronic label 7. Provision may also be made for the label identification data to be used to create an industrial coordinate 5 for an or the electronic label 7 and/or to add it to the industrial coordinate system 6, and/or to assign an industrial coordinate 5 to the electronic label 7. For example, the label identification data may comprise an industrial coordinate 5 of an electronic label 7. Alternatively or additionally, the label identification data may comprise a message, instruction and/or control command, on the basis of which the management system can identify and/or determine an or the electronic label, can create an industrial coordinate 5 for the electronic label 7 and/or can add it to the industrial coordinate system 6, and/or on the basis of which the management system 1 can create an or the instruction.

The part identification data and the label identification data may also be acquired and transmitted in a different order. For example, the label identification data may first be determined and/or transmitted before the part identification data are determined and/or transmitted.

In some embodiments, electronic label 7 may be attached to or arranged on good 9.

Provision may be made for an or the operator and/or user to acknowledge a storage of good 9. The acknowledgement may take place, for example, as described above.

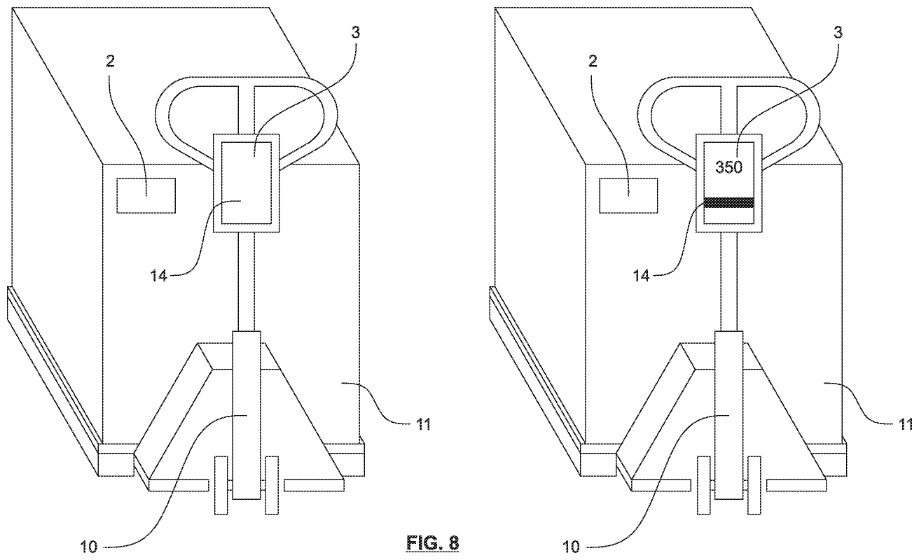

FIG. 8 shows yet a further exemplary embodiment of a mobile data acquisition device 3 and an identifier 2.

The mobile data acquisition device 3 may be arranged, attached and/or attached to a transport unit 10. The identifier 2 may be arranged, attached and/or attached to an object 11 to be transported.

Provision may be made for management system 1 to determine one of a storage location, parking location and/or destination location to which the object 11 to be transported is to be transported and/or transferred. The management system 1 may create an instruction which may comprise the determined storage location, parking location and/or destination location. The instruction may be communicated to the mobile data acquisition device 3. For example, the mobile data acquisition device 3 may display the storage location, parking location and/or destination location after receiving the instruction, e.g. on a display 14 (cf. e.g. FIG. 8 on the right).

Provision may be made for the industrial coordinate 5 of the object 11 to be transported and/or of the transport unit 10 to comprise the respective position thereof. For example, a constituent of the respective industrial coordinate 5 may map and/or represent the respective position. In some embodiments, the management system 1 may change and/or update the corresponding industrial coordinate 5 and/or the corresponding constituent thereof. For example, the management system 1 may change and/or update the corresponding industrial coordinate 5 and/or the corresponding constituent thereof such that it corresponds to the position of the object 11 and/or of the transport unit 10, for example if the latter has been transported at or to the storage location, parking location and/or destination location. In some embodiments, corresponding industrial coordinate 5 and/or the corresponding constituent may firstly comprise a provision location of the object 11 to be transported and/or of the transport unit 13 before the transport, and comprise the storage location, parking location and/or destination location after the transport of the object 11.

In some embodiments, the user and/or operator may communicate the new position of the object 11 to the management system 1 via the mobile data acquisition device 3, for example after the transport of the object 11. In some embodiments, alternatively or additionally, the mobile data acquisition device 3 may automatically and/or independently identify that the object has reached its destination position or the storage location, parking location and/or destination location. The mobile data acquisition device 3 may transmit the new position of the object 11 to the management system 1 and/or be set up for this purpose.

The features disclosed in the claims, the description and the figures may be essential for the implementation of the invention individually or in any combination.

1. A method for managing a storage system, a goods system and/or a production system, comprising:
acquiring an identifier (2) with a mobile data acquisition device (3), wherein the mobile data acquisition device (3) acquires information stored in the identifier (2);
transmitting the information to a management system (1) connected to the mobile data acquisition device (3) for data exchange;
identifying at least one object (4) of a plurality of objects by the management system (1), wherein a unique industrial coordinate (5) of an industrial coordinate system (6) is assigned to each object (4) and, during the identification, the unique industrial coordinates (5) of the object (4) to be identified are determined on the basis of the transmitted information, preferably the transmitted information are at least partially compared with industrial coordinates (5) of the industrial coordinate system (6) uniquely assigned to the respective objects (4);
creating an instruction on the basis of the identified object (4), the industrial coordinates (5) thereof and/or the transmitted information, and transmitting the instruction from the management system (1) to the mobile data acquisition device (3), the identified object (4) and/or to an external device connected to the management system (1) for data exchange; and
wherein the industrial coordinates (5) comprise at least one hierarchy level (8) and at least one, a plurality of or all hierarchy levels (8) correspond to a physical property, preferably an installation location, a storage location, an operating mode, a clock, a machine type, a product and/or production information, of the object (4) assigned to the respective industrial coordinate (5), wherein preferably the industrial coordinate system (6) structures the industrial coordinates (5) in a tree-shaped structure.

2. The method according to claim 1, in which the identifier (2) is acquired by a handheld scanner or by a functional glove.

3. The method according to claim 1, in which, when transmitting the information, auxiliary information is transmitted, preferably a location or a position, and when identifying the object (4), the identification, preferably one or the matching, takes place taking into account the auxiliary information.

4. The method according to claim 1, in which the method can preferably be used for picking goods by means of pick-by-light, wherein:
when acquiring the identifier (2), an order slip is acquired, preferably scanned, which comprises one or more goods to be picked, wherein preferably in each case an industrial coordinate (5) of the respective good (9) to be picked and/or preferably in each case an industrial coordinate (5) of a respective electronic label (7) assigned to the good (9) to be picked is acquired;
when identifying an electronic label (7) arranged on or at the goods to be picked is identified as an object (4) to be identified; and
when creating the instruction, an instruction which instructs the identified electronic label (7) to light up and/or to flash is created, and the instruction is transmitted to the identified electronic label, wherein the identified electronic label (7) lights up and/or flashes after the transmission.

5. The method according to claim 1, in which the method can preferably be used for storage by means of put-to-light, wherein at least one industrial coordinate (5) is assigned to the industrial coordinate system (6) according to a method comprising
acquiring a part identifier (13) of a good (9) to be stored, preferably a part identifier (13) arranged on or at the good (9) to be stored, with a or the mobile data acquisition device (3), wherein part identification data of the part identifier (13) are acquired;
transmitting the part identification data to the management system (1) connected to the mobile data acquisition device (3) for data exchange;
acquiring an electronic label (7) with the mobile data acquisition device (3), wherein label identification data of the electronic label (7) are acquired;
transmitting the label identification data to the management system (1) connected to the mobile data acquisition device (3) for data exchange;
creating an industrial coordinate (5), which is assigned to the electronic label (7) and/or the product (9), with the management system (1).

6. The method according to claim 5, in which after the creation of the industrial coordinate (5) an instruction is transmitted from the management system (1) to the electronic label (7), which instructs the electronic label (7) to light up and/or to flash, and after the transmission of the instruction the electronic label (7) lights up and/or flashes.

7. The method according to claim 5, in which the electronic label (7) is attached to the product (9).

8. The method according to claim 4, in which the electronic label (7) is scanned, and the mobile data acquisition device (3) transmits an acknowledgement to the management system (1).

9. The method according to claim 8, in which after the transmission of the acknowledgement the management system (1) changes or deletes an industrial coordinate (5) linked to the acknowledgement, and/or newly creates an industrial coordinate (5) and links it to the acknowledgement.

10. The method according to claim 1, in which:
when acquiring the identifier (2) the mobile data acquisition device (3) wirelessly acquires the identification data, wherein the identification data are automatically acquired by the mobile data acquisition device (3) if a distance between identifier (2) and mobile data acquisition distance is less than a minimum distance.

11. The method according to claim 1, in which the mobile data acquisition device (3) is attached to a transport unit (10) and the identifier (2) is attached to an object to be transported, and wherein the creation of the instruction comprises determining a storage location, parking location and/or destination location of the object to be transported.

12. The method according to claim 11, in which the industrial coordinate (5) assigned to the object to be transported does not comprise the storage location, parking location and/or destination location before the acquisition of the identifier (2), the transmission of the information and/or the determination of the instruction, and wherein the management system (1) changes the industrial coordinate (5) linked to the object after the acquisition of the identifier (2) and/or the transmission of the information and/or the determination of the instruction such that it comprises the storage location, parking location and/or destination location.

13. A system (100) comprising a mobile data acquisition device (3), a management system (1), and a plurality of objects, wherein an industrial coordinate (5) is assigned to each object (4), which are structured with an industrial coordinate system (6), wherein the industrial coordinates (5) comprise at least one hierarchy level (8) and at least one, a plurality of or all hierarchy levels (8) correspond to a physical property, preferably an installation location, a storage location, an operating mode, a clock, a machine type, a product and/or production information, of the object (4) assigned to the respective industrial coordinate (5), wherein the system (100) is configured to carry out the method according to claim 1.

14. The system (100) according to claim 13, wherein at least two, a plurality of or all of the industrial coordinates (5) have at least one common hierarchy level.

15. The system (100) according to claim 13, wherein at least two, a plurality of or all of the industrial coordinates (5) have the same number of hierarchy levels (8).
